(19) United States
(12) Patent Application Publication
(10) Pub. No.: US 2026/0213675 A1
(43) Pub. Date: Jul. 23, 2026

(54) CONVERTER AND METHOD FOR OPERATING SAME

(71) Applicant: SMA Solar Technology AG, Niestetal (DE)

(72) Inventors: Alexander Unru, Baunatal (DE); Mohamed Khshainy, Kassel (DE); Marcel Kratochvil, Kassel (DE)

(21) Appl. No.: 19/570,434

(22) Filed: Mar. 18, 2026

Related U.S. Application Data
(63) Continuation of application No. PCT/EP2024/076718, filed on Sep. 24, 2024.

(30) Foreign Application Priority Data
Oct. 9, 2023 (DE) 10 2023 127 503.8

(51) Int. Cl. H02M 7/493; H02M 7/217; H02M 7/537; H02M 7/797

(52) U.S. Cl. CPC H02M 7/493; H02M 7/217; H02M 7/537; H02M 7/797

(57) ABSTRACT

The application describes a converter for converting a direct current power to an alternating current power or vice-versa using a plurality of individual converters connected in parallel. Each of the individual converters include a power circuit and an internal controller configured to set the power flow through the corresponding individual converter depending on a DC voltage applied to a DC terminal of the corresponding individual converter. The converter also includes a higher-order controller configured to receive individual differential currents of each of the individual converters, to process same to form a setpoint value, and to transmit the setpoint value to the internal controllers of the individual converters. The internal controllers of the individual converters are configured to take into account the individual differential current and the transmitted setpoint value when setting the individual power flow that flows through the individual converter.

### REFERENCE TO RELATED APPLICATIONS

This application is a Continuation of International Application number PCT/EP2024/076718, filed on Sep. 24, 2024, which claims the benefit of German Application number 10 2023 127 503.8, filed on Oct. 9, 2023. The contents of the above-referenced Patent Applications are hereby incorporated by reference in their entirety.

### FIELD

The disclosure relates to a converter for converting electrical power, for example, a converter with a plurality of individual converters connected in parallel. The disclosure also relates to a method for operating such a converter, in particular to a method that aims for a symmetrical, or at least predefined, load on the plurality of individual converters.

### BACKGROUND

In some electrical consumption units, for example, in industrial plants, there are often a plurality of electrical consumers that are supplied via a direct current (DC voltage). Here, it is advisable to provide, as an alternative or in addition to an internal alternating current network (AC network), an internal direct current network (DC network) via which the individual DC consumers are connected. In this way, the number of separate AC/DC converters that would otherwise be needed for each of the DC consumers to connect to an AC network can be reduced and replaced by just a few AC/DC converters of higher power, which then supply the internal DC network from an AC terminal of the consumer unit or an internal AC network of the consumption unit.

In order to vary the nominal conversion power according to the total power of the DC consumers connected to the DC network, it is desirable to connect several AC/DC converters or several individual converters in parallel, so that they are each connected on the DC side to the internal DC network and on the AC side to the internal AC network or the AC terminal of the consumption unit. By connecting several individual converters in parallel, a large power flow can then be dynamically exchanged between the AC network and the DC network. The desired outcome is that, with identical nominal power ratings, the individual converters are also subjected to the same power flow during operation. If some of the individual converters are subjected to disproportionately high stress relative to other individual converters, for example, because the power flows assigned to the individual converters differ, this leads to faster aging and a resulting higher probability of failure in the more heavily stressed individual converters.

However, setting and maintaining a desired distribution, for example, a distribution of the power flow across the plurality of parallel-connected individual converters that is proportional to the nominal power of the individual converters, is not trivial. It is particularly challenging when it is additionally required that the total power flow provided by the multiple individual converters can vary highly dynamically, for example, to react to dynamic events in the AC network and/or the DC network. In order to implement highly dynamic internal regulation for each of the individual converters, it is advantageous that measured values used as input variables for the internal regulation are also detected within the individual converters themselves, if possible. If this is not the case, i.e., if the input variables for the regulation system are detected at a location remote from the individual converter in question, they would have to be communicated or transmitted to the internal regulation system. However, such communication is time-consuming, which limits the dynamics of the regulation, and/or costly, in particular when it has to take place over greater distances. Furthermore, it should be taken into account that input variables for the corresponding internal regulation, which are detected at the location of the individual converters, can differ from each other even with identical power flows through each of the individual converters. These differences can be caused, for example, by different tolerance values of the corresponding sensors used and their downstream measuring electronics. However, different cable or line impedances, for example, due to different line lengths between the corresponding individual converters and the DC network or the AC terminal, can also cause undesirable differences in the input variables of the regulation system. This makes it difficult to achieve highly dynamic regulation for each of the individual converters based solely on the measured values detected at the location of the individual converters.

The publication DE 10 2011 005 050 A1 discloses a control method for a power converter parallel circuit which comprises at least two semiconductor valves connected in parallel between an AC terminal and a DC terminal. A common ignition angle is specified by means of a regulation system, and an actual current is detected on the DC side. In this process, a partial flow passing through the corresponding semiconductor valve is recorded over a period of time and fed to a symmetry regulation system. A mean value is calculated for each of these recorded partial flows. Finally, from the resulting mean values, the actual current and the common ignition angle for each semiconductor valve, a corresponding ignition angle correction is derived, so that the loads on the semiconductor valves are approximated.

Publication WO 2015/197697 A1 discloses a switching power supply comprising at least two parallel-connected LLC resonant converters. Each LLC resonant converter comprises a measuring circuit that generates a measurement signal proportional to the current transmitted by the associated LLC resonant converter. Each measurement signal is fed into a load regulation system. In this process, at least one switching frequency of an LLC resonant converter is changed by means of the load regulation system in such a way that the measurement signals approximate each other, thereby achieving an exact current or power distribution when several LLC resonant converters are connected in parallel.

Publication DE 20 002 237 U1 discloses a device for operating an energy supply network that comprises at least one energy generator. The device comprises at least one DC bus operated with a direct current voltage and at least one AC bus operated with an alternating current voltage. The device also comprises a battery inverter for converting a battery voltage present on the DC bus into an alternating voltage present on the AC bus, a battery unit for supplying the battery inverter with a direct current voltage, and a regulation unit for regulating network parameters of the alternating voltage present on the AC bus. In this case, the at least one energy generator can be coupled to the power supply network via the AC bus.

Publication DE 10 2022 118 430 A1 discloses a method for reducing a circulating current in inverters connected in parallel on the DC and AC sides, each with a split link circuit, comprising for at least one inverter the following steps:
measuring a first and a second link circuit voltage of a first and second half of the split link circuit of the corresponding inverter,
measuring an AC-side differential current of the corresponding inverter,
determining a duty cycle for setting an AC-side output voltage of the corresponding inverter according to an AC setpoint voltage using the link circuit voltages and the AC-side differential current, and
adjusting the AC-side output voltage by controlling semiconductor switches of the corresponding inverter using the duty cycle.

### SUMMARY

The disclosure is directed to a converter for converting electrical power with a plurality of parallel-connected individual converters, which enables improved regulation of the electrical power flows flowing through the individual converters. The converter is able to achieve and maintain a predetermined distribution of the total power flow converted by the converter across the plurality of individual converters, for example, when the total power flow exhibits highly dynamic changes. The disclosure is also directed to a method for operating the converter which ensures the achievement and maintenance of a predetermined distribution of the total converted power flow between the individual converters.

A converter according to the disclosure is designed for converting a direct current power to an alternating current power and/or for converting an alternating current power to a direct current power. It comprises a plurality of individual converters connected in parallel on a DC side and an AC side thereof. Each of the individual converters has a power circuit, for example, an AC/DC converter, and an internal controller. Each of the internal controllers is configured to set the power flow through its assigned individual converter depending on a DC voltage U_{DC} applied to a DC terminal of the corresponding individual converter. The converter further comprises a higher-order controller that is configured to receive individual differential currents I_{Δκ} of each of the individual converters, to process same to form a setpoint value V_{Δ}, and to transmit the setpoint value V_{Δ} to the internal controllers of the individual converters. The internal controllers of the individual converters are each configured to take into account a corresponding individual differential current I_{Δk} and the transmitted setpoint value V_{Δ} when setting the individual power flow that flows through the respective individual converter.

A method according to the disclosure for operating such a converter comprises:
detecting the individual DC voltage U_{DC,k} assigned to the corresponding DC terminal for each of the individual converters;
detecting the individual differential current I_{Δk} for each of the individual converters;
processing the individual differential currents lax of the plurality of individual converters to form a setpoint value V_{Δ} by the higher-order controller and transmitting the setpoint value to the internal controllers of each individual converter, and
setting the individual power flow in the power circuit of each individual converter by its internal controller depending on the individual DC voltage U_{DC,k} applied to the DC terminal of the corresponding individual converter, the individual differential current I_{Δk} of the corresponding individual converter and the transmitted setpoint value V_{Δ}.

Each individual converter of the converter can be designed for a unidirectional power flow. In a first case, the unidirectional power flow can comprise a power flow from the DC network to the AC network, with each of the individual converters, and thus also the converter containing the individual converters, operating as an inverter. Alternatively, it is also possible that each of the individual converters is designed for a unidirectional power flow from the AC network to the DC network. Thus, each of the individual converters, and therefore the converter as a whole, can operate as a rectifier during operation. In addition, it is also possible that each of the individual converters, and therefore also the converter, is designed for bidirectional power flow. The power circuits of the individual converters can each be designed as a transistor-based AC/DC converter or each comprise a transistor-based AC/DC converter. The individual differential currents of the individual converters can each be AC-side differential currents, reflecting for each of the individual converters a difference of currents flowing in the individual phase conductors assigned to the corresponding individual converter. Alternatively, it can also be DC-side differential currents, which for each of the individual converters represent a difference between a current in an associated positive DC line and a current in an associated negative DC line. Regardless of whether the differential current is an AC-side or a DC-side differential current, it can be detected using a suitable differential current sensor, for example a through-type converter, which surrounds the corresponding DC lines or the corresponding phase conductors. With such a differential current sensor, the current difference is detected directly, without the need to know the specific currents in the relevant lines that contribute to the differential current. Alternatively, it is also possible to determine the individual differential currents by measuring the current flowing in each of the relevant DC lines or phase conductors individually, and then calculating the individual differential currents from the currents measured in the DC lines or from the currents measured in the phase conductors.

The disclosure utilizes the following effect: when operating the converter with the parallel-connected individual converters, it has been shown that the individual differential currents of the individual converters also represent a measure of the power flows currently flowing through the individual converters. This means that a relatively high individual differential current will also be detected in an individual converter through which a relatively high power flow occurs. Conversely, an individual converter that detects a relatively high differential current also simultaneously carries a relatively high power flow. The individual differential current can be an alternating current signal representing a current flowing against earth potential PE.

In the method according to the disclosure and the device according to the disclosure, this finding is now utilized to bring about a desired distribution of the power flows among the plurality of individual converters. Any deviation in the power flows through the individual converters from a desired distribution of the total power across the individual converters can be detected by detecting the individual differential currents. The higher-order controller can determine a setpoint value from the individual differential currents and transmit the setpoint value to the individual controllers of the individual converters. These, in turn, can use the setpoint value to bring about and maintain the desired distribution of power flows. The regulation of individual power flows through the individual converters can be carried out at least predominantly by the internal controllers of the individual converters, which, in addition to the setpoint value, primarily use the other electrical input variables that are also available or can be detected at the location of the individual converters. The majority of the regulation system therefore does not rely on communication with the higher-order controller, which may be located further away, but reacts to the locally measured input variables, taking the setpoint value into account, thus enabling the regulation system to react in a highly dynamic manner.

The setpoint value communicated by the higher-order controller to the internal controllers represents a correction of the individual power flows by the individual converters. The internal controllers regulate the individual power flows in such a way that the deviation between the corresponding individual differential currents and the setpoint value or a variable derived from the setpoint value is reduced. The individual power flows are usually corrected by a maximum of 30%, for example, by a maximum of 20% and for example by a maximum of 15% in relation to the nominal power of the individual converters.

Furthermore, the causal effects that lead to the deviation from the desired distribution of individual power flows are usually constant over time and show no, or only a slight, change over time. Examples of causal effects include, for example, different tolerances of the measuring sensors and different line lengths between the individual converters and their associated connection points with the common DC network or the common AC network. Therefore, any latency that may exist in the communication between the higher-order controller and the internal controllers of the individual converters has only a minor or negligible impact.

Advantageous embodiments of the disclosure are specified in the following description and the claims, the features of which can be applied individually and in any desired combination with one another.

In one embodiment of the converter, at least one of the individual converters assigned to it can have a split DC link circuit whose center point Mₖ is connected to an AC-side star point of the corresponding individual converter. This can occur not only with one, but also with several, and possibly even with each of the individual converters assigned to the converter. In this way, any shift of a voltage center point that may be generated or existing on the DC side of the corresponding individual converter is also coupled to its AC side. Conversely, this also feeds back any AC-side generated or existing shift of a voltage center point to its DC side. The detection of the individual differential current can therefore be carried out independently of which side (DC side or AC side) of the individual converter is responsible for the generation of the individual differential current.

In one embodiment of the converter, one, multiple, or optionally each of the individual converters can comprise an internal controller that has a PI controller. The PI controller can be configured to minimize a deviation between the individual differential current of an associated individual converter and the setpoint value, or to minimize a deviation between the individual differential current and a variable derived from the setpoint value, in particular a setpoint value for the individual differential current. The PI controller can be an analog PI controller, or alternatively, a computer-controlled PI controller. A combination of an analog and a computer-aided PI controller is also possible. The PI controller or the internal controller comprising the PI controller can, in particular, modify the power flow through the corresponding individual converter in order to thereby minimize the deviation between the individual differential current and the setpoint value or the variable derived therefrom.

In one embodiment of the converter, one of the individual converters, several of the individual converters, or optionally each of the individual converters can comprise a power circuit that is configured for bidirectional power transfer. In this way, the converter can transfer not only a unidirectional power flow, which in one case is directed exclusively from the AC network to the DC network, or in another case exclusively from the DC network to the AC network. Rather, the converter also enables a bidirectional power flow, whereby electrical power is transferred, for example, from the AC network to the DC network during one period and from the DC network to the AC network during another period.

In one embodiment of the method, the corresponding individual differential current on AC lines, for example, on phase conductors, for one, several, or optionally also for each of the individual converters can be detected. For this purpose, the AC lines at the AC-side terminal of the corresponding individual converter can be enclosed by a through-type converter (e.g., a toroidal current transformer for measuring a differential current). Alternatively or cumulatively, it is also possible to detect the individual differential current on the DC lines for one, several, or possibly each of the individual converters. This can be achieved by enclosing the DC lines of the individual converter in question with a through-type converter (e.g., a toroidal current transformer). As part of the method, it is also possible to perform the measurement of the individual differential currents on both the DC and AC sides. In this way, the accuracy of the measurement can be increased relative to detection on only one of the two sides of the individual converter.

In one embodiment of the converter, all individual converters assigned to it can have the same nominal power. The total power output of the converter can thus be changed or adjusted by changing the number of parallel-connected individual converters in equidistant steps. Alternatively, it is also possible that the converter comprises various individual converters with different nominal power ratings. In this variant, the nominal power of at least one of the individual converters can differ from the nominal power of another of the individual converters. This allows the total power output of the converter to be adjusted in different, non-equidistant power levels, and thus often in a more needs-based or application-oriented manner.

Regardless of whether the individual converters have the same or different nominal power outputs, the adjustment of the individual power flows at the individual converters can be carried out according to different strategies. According to one initial strategy, the absolute values of the individual power flows through the individual converters can be equalized. This is advantageous, for example, if all individual converters have the same nominal power and a uniform load on the converters is desired. According to a second strategy, the relative loads on the individual converters related to a corresponding nominal power can be equalized. This is advantageous in one embodiment when the individual converters have different nominal power outputs. According to a third strategy, the power flow through one or more of the individual converters can also be interrupted by deactivating the individual converters in question. In this process, the individual power flow that previously flowed through the deactivated individual converter, or the individual power flows that previously flowed through the deactivated individual converters, can be distributed to the remaining individual converters that are still actively operating. This strategy can be advantageous if the overall efficiency of the converter during power conversion is to be optimized. For example, an existing power flow can be divided among a fraction of the total available individual converters, which then operate with high efficiency, while at least one, or possibly several, individual converters are deactivated.

In this method, each of the individual converters can equalize the corresponding individual differential current to the setpoint value or to a variable formed from the setpoint value by adjusting the power flow in its power circuit. In the first variant, a common setpoint value for the individual differential current, valid for all individual converters, can be directly communicated from the higher-order controller to the individual controllers of the individual converters. In the second variant, the communicated setpoint value can represent an auxiliary variable used jointly by the individual converters, which is not directly identical to a setpoint for the individual differential current. Rather, the communicated setpoint value can be used by the individual controllers to derive a setpoint for the individual differential current. This approach can be advantageous if the setpoint values for the individual differential currents of the individual converters differ from each other, or change over time according to a predefined regularity.

The setpoint value can be a sum or a mean value (Ĩ_{Δ}) of the individual differential currents. Alternatively, the setpoint value can also comprise a mean value of the individual differential currents weighted by the nominal power of the corresponding individual converter.

In this method, one, several or optionally each of the individual converters can use a modulation method in its operation, in which a periodic fluctuation of a potential, which is assigned to a voltage center point of the corresponding side, is generated on the AC side and/or DC side. Using such a modulation method, when converting a given DC voltage into a multi-phase AC voltage, an AC voltage applied between the phase conductors can be increased relative to a variant without a modulation method. Conversely, when using such a modulation method, a lower DC voltage can be used for conversion to a given multiphase AC voltage. Such a modulation method with a modulated voltage center point, for example, of the DC voltage, not only increases the individual differential currents themselves, but also the dependence of the individual differential currents on their respectively assigned individual power flows. Therefore, the method can be applied particularly well to a converter whose individual converters use such a modulation method. The modulation method can, for example, comprise a so-called flat-top modulation, in which the fluctuation of the potential assigned to the voltage center point relative to the earth potential PE corresponds at least largely to a sinusoidal fluctuation. Alternatively, it is also possible to generate a triangular fluctuation of the potential assigned to the voltage center point relative to the earth potential PE using the modulation method.

Regardless of which of the two modulations mentioned above is used, the method has shown that when the converter is connected to an m-phase AC network on the AC side, the individual differential current of each of the individual converters has an AC current with m times the network frequency. Here, m denotes any natural number, preferably an odd number. In such a case, the individual differential currents can be filtered out during or after their detection using a suitable filter designed for the m-fold frequency of the m-phase AC network that occurs predominantly here. In this way, the detected individual differential currents can at least be largely freed from any interfering signals that may be present, thereby optimizing the measurement accuracy of the method.

### BRIEF DESCRIPTION OF THE FIGURES

The disclosure is illustrated below with the aid of figures. In the figures:

FIG. 1 shows an embodiment of a converter according to the disclosure;

FIG. 2 shows an individual converter of the converter in FIG. 1 in one embodiment,

FIG. 3 shows different embodiments of a characteristic curve for controlling the power flow for the individual converter from FIG. 2, and

FIG. 4 shows a flowchart for an embodiment of the method according to the disclosure.

### DETAILED DESCRIPTION

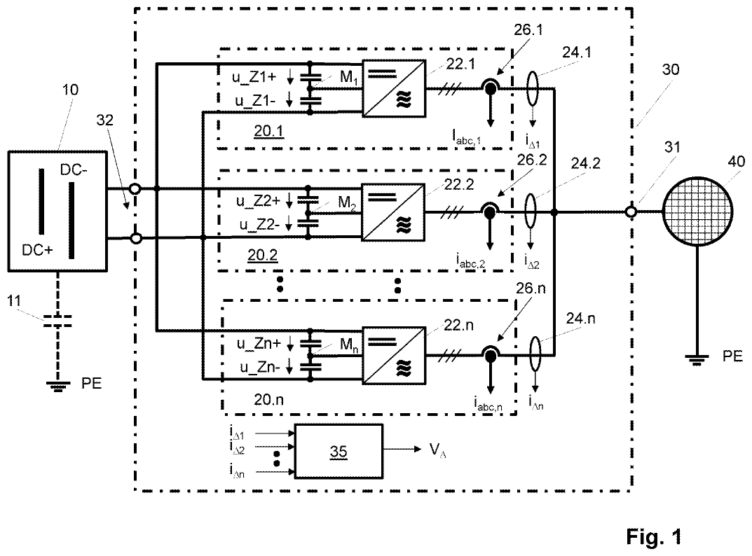

FIG. 1 shows a first embodiment of a converter 30 according to the disclosure. The converter 30 comprises an AC converter terminal 31 connected to an AC network 40 and a DC converter terminal 32 connected to a DC network 10. It further comprises a plurality n of individual converters 20.1-20.n, which are connected in parallel to each other on the DC side via the DC converter terminal 32 to the DC network 10 and on the AC side via the AC converter terminal 31 to the AC network 40. Each of the individual converters 20.1-20.n includes a power circuit 22.1-22.n in the form of an AC/DC converter, for example, in the form of a transistor-based AC/DC converter. Each of the individual converters 20.1-20.n has a current sensor 26.1-26.n for detecting the currents I_{abc,1}-I_{abc,n} in the individual phase conductors a, b, c of the corresponding individual converter 20.1-20.n. On the AC side, each individual converter 20.1-20.n is assigned a differential current sensor 24.1-24.n, which is designed to measure an individual differential current I_{Δ1}-I_{Δn} to detect the phase conductors a,b,c assigned to the corresponding individual converter 20.1-20.n. The converter 30 also comprises a higher-order controller 35 for controlling the individual converters 20.1-20.n.

In FIG. 1, the individual converters 20.1-20.n are shown as examples of bidirectional individual converters 20.1-20.n, which can transfer a power flow from the DC network 10 to the AC network 40 in an alternating operating mode, as well as a power flow from the AC network 40 to the DC network 10 in a rectifying operating mode. Alternatively, it is also possible that one, several or each of the individual converters 20.1-20.n is designed as a purely unidirectional individual converter 20.1-20.n and is therefore designed either only for alternating operation or only for rectifying operation.

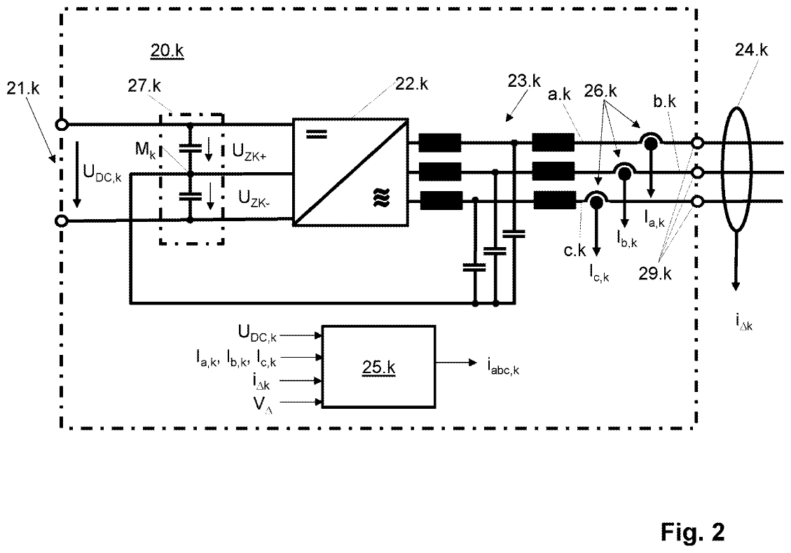

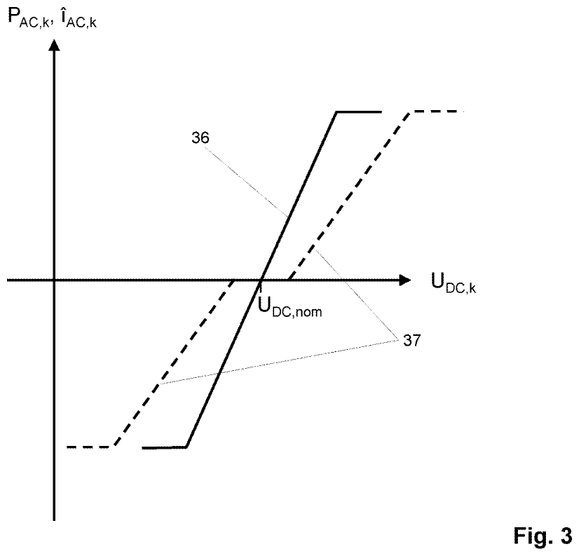

In operation of the converter 30 according to one embodiment, a power flow in each of the individual converters 20.1-20.n is controlled by an internal controller of the individual converters (not explicitly shown in FIG. 1) according to a characteristic curve, for example a current-voltage characteristic curve I_{AC} (U_{DC}) or a power-voltage characteristic curve P_{AC}(U_{DC}) as shown in FIG. 3. For this purpose, the internal controller of the individual converters 20.1-20.n, as also explained in detail in connection with FIG. 2 and FIG. 3, uses at least predominantly input variables that can be detected at the location of the corresponding individual converters 20.1-20.n. In this way, the regulation within each individual converter 20.1-20.n can operate very dynamically.

During the operation of the converter 30, periodic potential fluctuations of a voltage center point relative to earth potential PE typically occur. These potential fluctuations can be present on the DC side at each of the individual converters as well as at the DC converter terminal 32. Alternatively or cumulatively, the AC-side voltage center point and thus also the AC converter terminal 31 can exhibit such potential fluctuations relative to potential earth PE. The DC-side potential fluctuations on the DC side of the individual converters 20.1-20.n generate a periodically changing individual differential current for each of the individual converters, which flows against potential earth PE via the always present parasitic capacitor 11 of the DC network 10.

The AC/DC converters can each comprise a 3-level topology with a DC-link circuit having an upper half with the voltage U_ZK+ and a lower half with the voltage U_ZK− and a center point Mk. During operation of the AC/DC converters their respective center points may fluctuate around earth. This can be caused, e.g. by an asymmetric load situation of the upper and the lower half of the DC-link circuit leading to fluctuations of the respective voltages U_ZK+, and U_ZK− relative to each other. Another cause of the fluctuating center point Mₖ may also be a modulation which as part of a control strategy of the AC/DC-converter is present during operation. Since the center point Mk on the DC-side is connected to a voltage center point on the AC-side given by the common connection point of the filter capacitors, the potential fluctuations of Mₖ on the DC-side are crosslinked to respective potential fluctuations of the common connection point of the filter capacitors on the AC side.

The DC-side comprises parasitic capacitances between the DC+ line and PE and between the DC-line and PE. This is symbolized in FIG. 1 with the capacitance 11 illustrated in a dashed line format. If now there is a slight coupling between the common star point of the filter capacitors and PE on the AC side (e.g. due to the fact that the filter capacitors act as a voltage divider between the phase lines similar to a star point of a transformer), that slight coupling is also present between the center point Mk and PE on the DC-side. Thus, whenever there is a potential fluctuation of Mₖ relative to earth potential PE, there is a common mode signal on the DC+ and the DC− line relative to earth PE. Consequently, the parasitic capacitances on the DC-side also will be charged/discharged with an individual differential current.

On the AC side, there is also usually a capacitive coupling between the AC-side voltage center point and potential earth PE, for example, via a filter arranged there, which is why a corresponding individual differential current is also generated on the AC side between the AC-side voltage center point and potential earth PE. The individual differential currents I_{Δ1}-I_{Δn} are detected for each of the individual converters 20.1-20.n via a corresponding differential current sensor 24.1-24.n. In FIG. 1, the differential current sensors 24.1-24.n are designed by way of example in the form of a through-type converter and arranged on the AC side of the individual converters 20.1-20.n. Alternatively, it is also possible to arrange the differential current sensors 24.1-24.n on the DC side of each of the individual converters.

As has been shown, the potential fluctuations of the voltage center points relative to PE and thus the individual differential currents I_{Δ1}-I_{Δn} generated at the location of the individual converters 20.1-20.n also constitute at the same time a measure of the power flows through the corresponding individual converters 20.1-20.n. This is particularly the case if the individual converters 20.1-20.n in their operation exhibit a modulation method with a modulated voltage center point, for example, of the DC voltage, for example, a flat-top modulation. By then connecting the differential current sensors 24.1-24.n to the higher-order controller 35 of the converter 30 for control purposes and data exchange, the detected individual differential currents I_{Δ1}-I_{Δn} of each of the individual converters 35 can be transmitted to the higher-order controller 35, which is symbolized in FIG. 1 by corresponding input arrows on the higher-order controller 35. The higher-order controller 35 of the converter 30 processes the individual differential currents I_{Δ1}-I_{Δn} to form a setpoint value V_{Δ} and communicates the setpoint value V_{Δ} to the internal controllers of the individual converters 20.1-20.n. This is symbolized in FIG. 1 by an output arrow at the higher-order controller 35. The setpoint value can, for example, comprise a mean value of the individual differential currents I_{Δ1}-I_{Δn}. The internal controllers of the individual converters 20.1-20.n are each configured to take the setpoint value V_{Δ} into account when adjusting the individual power flow through the individual converter 20.1-20.n assigned to them. In this way, any existing asymmetry or disproportionality in the distribution of the individual power flows through the multiple individual converters 20.1-20.n can be identified and eliminated. This also makes it possible to identify and eliminate a deviation from a desired distribution of individual power flows.

FIG. 2 shows in more detail an embodiment of an individual converter 20.k of the converter 30 from FIG. 1. The individual converter 20.k has a DC terminal 21.k which is connected via a DC link circuit 27.k to a DC side of the power circuit 22.k. In FIG. 2, the power circuit 22.k is shown as an example of a bidirectional DC/AC converter with a transistor-based bridge circuit. The DC link circuit 27.k is designed as a two-part DC link circuit with an upper link circuit half and a lower link circuit half, which are connected to each other by a center point M_{K} of the link circuit. The voltage U_{ZK+} is applied to the upper link circuit half, while the voltage U_{ZK-} is applied to the lower link circuit half. On the AC side, the power circuit 22.k is connected via an LCL filter 23.k to the AC terminal 29.k of the individual converter 20.k. The DC-side center point M_{K} of the link circuit 27.k is connected to a star point formed by the capacitances of the LCL filter on the AC side of the individual converter 20.k. Inside the converter 30, the DC terminal 21.k of the individual converter 20.k is connected to the DC converter terminal 32 and the AC terminal 29.k of the individual converter 20.k is connected to the AC converter terminal 31.

The individual converter 20.k also has an internal controller 25.k which controls the power circuit 22.k of the individual converter 20.k to drive a power flow either in alternating operation from the DC terminal 21.k to the AC terminal 29.k or in rectifying operation from the AC terminal 29.k to the DC terminal 21.k. A current sensor 26.k for detecting a current I_{a.k}, i_{b.k}, i_{c.k} flowing in the corresponding phase conductors a, b, c of the individual converter 20.k is arranged on each of the AC-side phase conductors a, b, c of the individual converter 20.k. The current sensors 26.k are connected to the internal controller 25.k for control purposes, for example, to use the detected currents I_{a.k}, i_{b.k}, i_{c.k} in the regulation system, for example, for a target/actual comparison. The differential current sensor 24.k, also shown in FIG. 1, is arranged at the AC output 29.k of the individual converter 20.k in order to detect the individual differential current I_{Δk} of the individual converter 20.k on the AC side and to transfer it to the higher-order controller 35 of the converter 30.

In order to enable the regulation system of the individual converter 20.k to react as dynamically as possible overall, its internal controller 25.k (as well as the internal controllers 25.j of the other individual converters 20.j with j≠k) primarily uses input variables that are also available at the location of the (respective) individual converter 20.k. Such input variables include, for example, a DC voltage U_{DC,k} applied to the DC terminal 21.k and the currents I_{a,k}, I_{b,k}, I_{c,k} detected at the phase conductors a.k, b.k, c.k of the corresponding individual converter 20.k, which can be passed to the internal controller 25.k for the purpose of providing monitoring feedback, for example. The individual differential current I_{Δk} assigned to the individual converter 20.k can also represent such an input variable, since it is detected at the location of the individual converter 20.k. Additionally, the internal controller 25.k also receives, as a parameter from the higher-order controller 35 of the converter 30, the setpoint value V_{Δ} which the higher-order controller 35 has determined from the individual differential currents I_{Δ1}-I_{Δn} of each of the individual converters 20.1-20.n. The setpoint value V_{Δ} can directly constitute a setpoint value for the individual differential current I_{Δk} of the individual converter 20.k. However, it can also represent an auxiliary variable from which the internal controller 25.k determines a setpoint value for the differential current of the individual converter 20.k. The values used for the internal controller 25.k are symbolized in FIG. 2 by corresponding input arrows pointing to the internal controller 25.k.

The following describes the operation of the individual converter 20.k from FIG. 2 using an example. The task of the converter 30 comprising the individual converter 20.k in the example is to supply a DC network 10 and connected, possibly regenerative consumers (not shown in FIG. 1) from the AC network 40. The voltage of the DC network 10 should be kept as close as possible to a nominal voltage U_{DC,nom} assigned to it. In case of deviations from the nominal voltage U_{DC,nom} the converter 30 is intended to counteract this deviation by means of suitable power transfer from or into the AC network 40. During its operation, the distribution of the individual power flows through the individual converters 20.1-20.n should correspond as closely as possible to a predefined distribution. If the individual power flow of an individual converter or the individual power flows of several individual converters deviate from the predefined distribution of power flows, their power flows should be adjusted so that they approximate those individual power flows that are specified by the predefined distribution.

For this purpose, a characteristic curve for the regulation of the individual power flow assigned to the individual converter 20.k is stored in the internal controller 25.k. The characteristic curve can be, for example, a power-voltage characteristic curve or a current-voltage characteristic curve, as shown schematically in FIG. 3. The internal controller 25.k now controls the power circuit 22.k in such a way that the latter transfers an individual power flow between the AC network 40 and the DC network 10 according to the stored characteristic curve, which power flow has a value assigned to the DC voltage U_{DC,k} applied to the DC terminal 21.k. Depending on and as a measure of the individual power flow of the individual converter 20.k, an individual differential current I_{Δk} is obtained which is detected at the location of the individual converter 20.k with the differential current sensor 24.k and transmitted to the internal controller 25.k, as well as to the higher-order controller 35.

If the detected individual differential current I_{Δk} now corresponds to the setpoint or target value assigned to it, this is interpreted by the internal controller 25.k as meaning that the individual power flow through the individual converter 20.k corresponds to the individual power flow that should be present at the individual converter 20.k according to the specified and desired distribution of power flows. In the event that the detected individual differential current I_{Δk} deviates from the setpoint or target value assigned to it, this is interpreted by the internal controller 25.k as a signal that the individual power flow of the individual converter 20.k also deviates from the assigned power setpoint value which results from the specified or desired distribution of the individual power flows. In this case, the internal controller 25.k controls the power circuit 22.k by increasing or decreasing the individual power flow in such a way that the individual differential current is approximated to its setpoint or target value. This also brings the distribution of individual power flows closer to the predefined distribution. This is also the case if effects such as different line lengths and line impedances would otherwise prevent the desired distribution from being achieved.

FIG. 3 schematically shows two different embodiments of a characteristic curve, such as can be stored in the internal controller 25.k of the individual converter from FIG. 2 to control the power flow. The two characteristic curves 36 and 37 can each be a power-voltage characteristic curve P_{AC,k} (U_{DC,k}). In this case, a DC voltage U_{DC,k} measured at the DC terminal 21.k of the individual converter 20.k is assigned an individual power flow P_{AC} to be transferred between the AC network 40 and the DC network 10. Alternatively, however, it may also be a current-voltage characteristic curve. In this case, the DC voltage U_{DC,k} at the DC terminal 21.k of the individual converter 20.k is assigned a current amplitude of an alternating current to be transferred to the AC network 40.

Positive values for power P_{AC,k} and current amplitude I_{AC,k} mean in each case that the individual power flow takes place from the DC network 10 to the AC network 40, while negative values for the power P_{AC,k} and current amplitude I_{AC,k} indicate a power flow from the AC network 40 to the DC network 10. Both characteristic curves 36 and 37 aim to keep the voltage in the DC network 10 as constant as possible at a nominal value U_{DC,nom} and to counteract a deviation from this nominal value U_{DC,nom} by means of a corresponding power transfer between the AC network 40 and the DC network 10. The characteristic curve 37 differs from the characteristic curve 36 in that, unlike the characteristic curve 36, in a range around the nominal value U_{DC,nom}, it has a deadband in which no power flow occurs via the corresponding individual converter 20.k between the AC network 40 and the DC network 10.

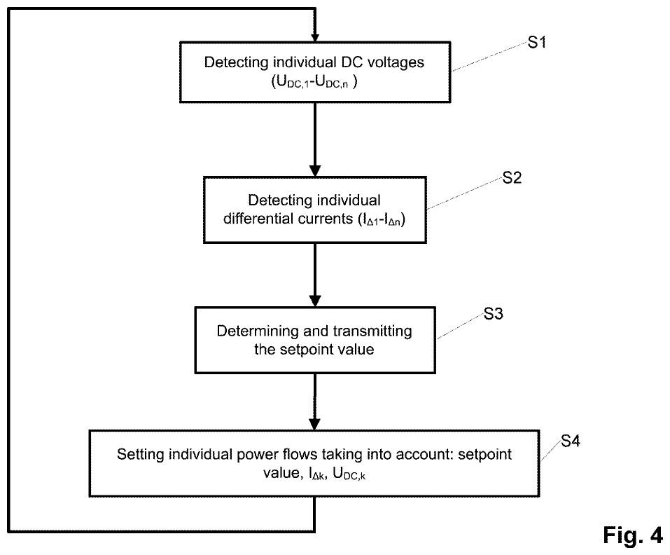

FIG. 4 shows a flowchart for an embodiment of the method according to the disclosure. The method starts in a first act S1, in which each of the n individual converters 20.k of the converter 30 detects the DC voltage U_{DC,k} applied to its DC terminal 21.k. In a second act S2, the individual differential currents I_{Δk} assigned to the corresponding individual converter 20.k with k=1·n are detected at each of the individual converters 20.k of the converter 30 and transmitted to the higher-order controller 35 of the converter 30. Additionally, for each of the individual converters 20.k, the individual differential current I_{Δk} detected at the individual converter 20.k is also transmitted to the internal controller 25.k of the corresponding individual converter 20.k. In a third act S3, the higher-order controller determines a setpoint value V_{Δ} from all the individual differential currents and transmits the setpoint value V_{Δ} to the internal controllers 25.k of the individual converters 20.k. In a fourth act S4, the internal controllers 25.k set individual power flows for each of the individual converters 20.k by appropriately controlling the power circuits 22.k. In doing so, they each take into account the DC voltage U_{DC,k} present at the DC terminal 21.k of the individual converter 20.k assigned to them, the individual differential current I_{Δk} assigned to them and the setpoint value V_{Δ} transmitted by the higher-order controller 35. The individual power flows are set in such a way that the individual differential currents I_{Δk} each correspond to the setpoint values assigned to them. The method jumps from the fourth act S4 to the first act S1 and the acts are repeated. The repeated execution of acts S1-S4 results in continuous regulation for the individual power flow through each of the individual converters 20.1-20.n as well as for the total power flow of the converter 30 formed by the individual converters 20.1-20.n.

What is claimed is:

1. A converter for converting a direct current power to an alternating current power and/or for converting an alternating current power to a direct current power comprising a plurality of individual converters connected in parallel on a DC side and an AC side of the respective individual converters,
wherein each of the individual converters comprises a power circuit and an internal controller that is configured to set a power flow through the corresponding individual converter depending on a DC voltage applied to a DC terminal of the corresponding individual converter,
wherein the converter comprises a higher-order controller that is configured to receive individual differential currents of each of the individual converters, to process the received individual differential currents to form a setpoint value, and to transmit the setpoint value to the internal controllers of the individual converters,
wherein the internal controllers of the individual converters are each configured to take into account a corresponding individual differential current and the transmitted setpoint value when setting an individual power flow that flows through the individual converter.

2. The converter according to claim 1, wherein at least one of the individual converters has a split DC link circuit comprising a center point Mₖ that is connected to an AC-side star point of the corresponding individual converter.

3. The converter according to claim 1, wherein at least one of the internal controllers of the individual converters comprises a PI controller configured to minimize a deviation between a corresponding individual differential current and the setpoint value or a variable formed from the setpoint value.

4. The converter according to claim 1, wherein at least one of the individual converters comprises a power circuit configured for bidirectional power transfer.

5. The converter according to claim 1, wherein all individual converters have a same nominal power.

6. The converter according to claim 1, wherein a nominal power of at least one of the individual converters differs from a nominal power of another individual converter of the plurality of individual converters.

7. A method for operating a converter that comprises a plurality of individual converters connected in parallel on a DC side and an AC side of the respective individual converters, wherein each of the individual converters comprise a power circuit and an internal controller and the converter comprises a higher-order controller, the method comprising:
detecting an individual DC voltage assigned to a corresponding DC terminal for each of the individual converters;
detecting an individual differential current for each of the individual converters;
processing the detected individual differential currents to form a setpoint value using the higher-order controller and transmitting the setpoint value to the internal controllers of each individual converter, and
setting an individual power flow at the power circuit of each individual converter by its internal controller depending on the detected individual DC voltage applied to the DC terminal of the corresponding individual converter, the detected individual differential current of the corresponding individual converter and the transmitted setpoint value.

8. The method according to claim 7, wherein for at least one of the individual converters the corresponding individual differential current is detected on AC lines of the corresponding individual converter.

9. The method according to claim 7, wherein for at least one of the individual converters the individual differential current is detected on DC lines of the corresponding individual converter.

10. The method according to claim 7, wherein the setpoint value comprises a sum of the individual differential currents, a mean value of the individual differential currents, or a mean value of the individual differential currents weighted by a nominal power of the corresponding individual converter.

11. The method according to claim 7, wherein each of the individual converters equalizes the corresponding individual differential current to the setpoint value or to a variable formed from the setpoint value by adjusting a power flow at the power circuit.

12. The method according to claim 7, wherein the setting of the individual power flows at the individual converters is carried out such that:
absolute values of the individual power flows are equalized, and/or
relative loads of the individual converters related to a corresponding nominal power are equalized, and/or
a power flow through one or more of the individual converters is interrupted and distributed to the remaining individual converters of the plurality of individual converters.

13. The method according to claim 7, wherein at least one of the individual converters uses in its operation a modulation method in which a periodic fluctuation of a potential assigned to a voltage center point is generated on the AC side and/or the DC side thereof.

14. The method according to claim 13, wherein the modulation method comprises a flat-top modulation, or wherein the modulation method generates a triangular fluctuation of the potential associated with the voltage center point.

15. The method according to claim 13, wherein the converter is connected on an AC side thereof to an n-phase AC network, wherein the individual differential current of each of the individual converters has an AC current at n times a network frequency.
